(19) United States
(12) Patent Application Publication
(10) Pub. No.: US 2022/0368890 A1
(43) Pub. Date: Nov. 17, 2022

(54) MOST PROBABLE MODE SIGNALING WITH MULTIPLE REFERENCE LINE INTRA PREDICTION

(71) Applicant: INTERDIGITAL VC HOLDINGS FRANCE, SAS, Cesson-Sevigne (FR)

(72) Inventors: Gagan RATH, Rennes (FR); Franck GALPIN, Thorigne-Fouillard (FR); Fabrice LELEANNEC, Betton (FR)

(21) Appl. No.: 17/760,914

(22) PCT Filed: Sep. 21, 2020
(86) PCT No.: PCT/EP2020/076212

§ 371 Date: Mar. 16, 2022

(30) Foreign Application Priority Data
Sep. 24, 2019 (EP) 19306179.3

(51) Int. Cl. H04N 19/105; H04N 19/13; H04N 19/159; H04N 19/46

(52) U.S. Cl. CPC H04N 19/105; H04N 19/13; H04N 19/159; H04N 19/46

(57) ABSTRACT

A most probable mode flag is context encoded in an encoder using multiple reference lines. In a corresponding decoder, the most probable mode flag is always decoded regardless of the value of a multiple reference line index flag. When multiple reference line index is nonzero, a context is used in parsing of the most probable mode flag.

### TECHNICAL FIELD

At least one of the present embodiments generally relates to a method or an apparatus for video encoding or decoding, compression or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

At least one of the present embodiments generally relates to a method or an apparatus for video encoding or decoding, and more particularly, to a method or an apparatus for Most Probable Mode (MPM) flag signaling with Multiple Reference Line (MRL) intra prediction. Both MPM and MRL are video coding tools in the VVC (Versatile Video Coding or H.266) standard, however, the described embodiments can apply to other video coding standards as well.

According to a first aspect, there is provided a method. The method comprises steps for parsing a video bitstream to determine whether multiple reference line intra coding is used; decoding a most probable mode flag based on said determination using a CABAC context to determine an intra coding mode; and, decoding said video bitstream based on said intra coding mode.

According to a second aspect, there is provided a method. The method comprises steps for encoding a flag indicative of multiple reference line intra video coding with a CABAC context; encoding an intra coding mode index representative of an intra coding mode used; and, encoding a video bitstream with said encoded flag and intra coding mode index using said intra coding mode.

According to another aspect, there is provided an apparatus. The apparatus comprises a processor. The processor can be configured to encode a block of a video or decode a bitstream by executing any of the aforementioned methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates coding unit locations for deriving MPM lists in another method for different target block shapes.

FIG. 2 illustrates a flowgraph of intra mode decoding in VVC.

FIG. 3 illustrates one embodiment of a flowgraph of intra mode decoding using the described aspects.

FIG. 4 illustrates a standard, generic, video compression scheme (encoder).

FIG. 5 illustrates a standard, generic, video decompression scheme (decoder).

FIG. 6 illustrates a processor based system for encoding/decoding under the general described aspects.

FIG. 7 illustrates a method for decoding using the described aspects.

FIG. 8 illustrates a method for encoding using the described aspects.

FIG. 9 illustrates an apparatus for encoding or decoding using the described aspects.

### DETAILED DESCRIPTION

The general described aspects address intra prediction mode coding in Versatile Video Coding (VVC) VTM 6.0. In particular, the encoding of the mpmFlag in presence of Multiple Reference Line (MRL) intra prediction is considered. In VTM 6.0, when the multiRefldx of any CU is non-zero, its prediction mode is constrained to be a member of the Most Probable Modes (MPM) list. As a consequence of this, the mpmFlag, which signals if the prediction mode belongs to the MPM list or not, is not encoded. The decoder thus skips decoding the mpmFlag if multiRefldx is non-zero. The current described aspects propose to encode the mpmFlag with a value of 1 but with another context even if multiRefldx is non-zero.

The described embodiments address the encoding of the mpmFlag in the presence of MRL in VTM 6.0. In the case when the multiRefldx is zero, the mpmFlag is encoded as in VTM 6.0 depending on the value of the intra prediction mode. If the prediction mode belongs to the MPM list, the mpmFlag is set as 1, else it is set as 0, before the flag is context encoded. In the case when multiRefldx is nonzero, the mpmFlag is set to 1 before encoding it with another context. With this change, the mpmFflag for a CU is always encoded. This leads to a better parsing and implementation at the decoder side. Furthermore, it allows all intra prediction modes to be considered with all reference lines available for a CU.

Versatile Video Coding Test Model 6.0 (VTM) supports intra prediction with multiple reference lines (MRL) where three reference lines are considered for the intra prediction of any CU. Besides the immediate neighboring reference line, also called the 0^{th} reference line, consisting of the immediate top and left reference samples, the reference lines at offset 1 and 3 pixels are also considered. However, with these reference lines, only the intra prediction modes in the most probable modes (MPM) list except the PLANAR mode are considered. Therefore, when the prediction mode of the CU is encoded, if its MRL index flag (denoted as multiRefldx) is non-zero, then the mpmFlag is not encoded. Only the index of the candidate MPM in the MPM list is encoded with a VLC scheme. Correspondingly, the decoder skips the decoding of the mpmFlag if the decoded value of the MRL index is non-zero before decoding the candidate MPM index. The aim of the described embodiments is to remove this inhomogeneity in mpmFlag signaling and to propose a better signaling method keeping the parsing and implementation of the decoder in view.

### MPM List Construction in VTM 6.0

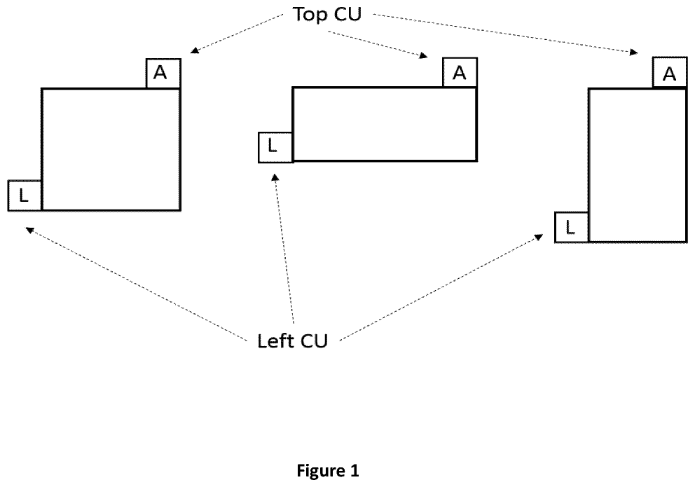

VTM 6.0 constructs an MPM list of 6 prediction modes for encoding the intra prediction mode of a target block. The MPM list is constructed from the prediction modes of the intra coded CUs on the top and left of the current CU and some default modes such as the PLANAR mode, the DC mode, the vertical mode, and the horizontal mode. The top and left CUs are at the right and bottom edge of the target block, respectively, as shown in FIG. 1. The list of 6 MPMs is constructed as shown in Table 1:

TABLE 1
MPM derivation in alternate proposal. A and L denote the prediction modes of Above
and Left CUs respectively. D = max(L, A) − min(L, A)

| Conditions | | | MPM[0] | MPM[1] | MPM[2] | MPM[3] | MPM[4] | MPM[5] |
|---|---|---|---|---|---|---|---|---|
| L = A | L ≠ PLANAR_IDX and | | PLANAR_IDX | L | L − 1 | L + 1 | L − 2 | L + 2 |
| | L ≠ DC_IDX | | | | | | | |
| | Otherwise | | PLANAR_IDX | DC_IDX | VER_IDX | HOR_IDX | VER_IDX − 4 | VER_IDX + 4 |
| L ≠ A | L > DC_IDX and A > | | PLANAR_IDX | L | A | min(L, A) − 1 if D = 1 | max(L, A) + 1 | min(L, A) − 2, |
| | DC_IDX | | | | | min(L, A) + 1 if D >= 62; | if D = 1; | if D = 1; |
| | | | | | | min(L, A) + 1 if D = 2 | max(L, A) − 1 | min(L, A) + 2 |
| | | | | | | min(L, A) − 1, | if D >= 62; | if D >= 62 |
| | | | | | | otherwise; | min(L, A) − 1 | max(L, A) + 1 |
| | | | | | | | if D = 2 | if D = 2 |
| | | | | | | | min(L, A) + 1 | max(L, A) − 1 |
| | | | | | | | otherwise; | otherwise; |
| | Otherwise | L + A >= 2 | PLANAR_IDX | max(L, A) | max(L, A) − 1 | max(L, A) + 1 | max(L, A) − 2 | max(L, A) + 2 |
| | | otherwise | PLANAR_IDX | DC_IDX | VER_IDX | HOR_IDX | VER_IDX − 4 | VER_IDX + 4 |

### Intra Mode Coding in VTM 6.0

In regular intra prediction or intra prediction with sub-partitions (ISP), if the prediction mode of the current block is equal to one of the six MPM modes, this is indicated by setting the mpmFlag with value 1 and then encoding the candidate mode index from the MPM list using the variable length coding scheme shown in Table 2. Otherwise, the mpmFlag is set as 0 and the candidate index in the set of remaining 61 modes is truncated-binary encoded with 5 or 6 bits. The single bin of the mpmFlag is context-encoded by CABAC. Similarly, the first bin of the MPM candidate index binarization, as shown in Table 2, is context-encoded but the remaining bins are bypass-encoded by CABAC.

TABLE 2
MPM encoding in another proposal

| Candidate | |
|---|---|
| Index | code |
| MPM[0] | 0 |
| MPM[1] | 10 |
| MPM[2] | 110 |
| MPM[3] | 1110 |
| MPM[4] | 11110 |
| MPM[5] | 11111 |

For intra prediction with MRL, the reference line used for the prediction is encoded with a flag called multiRefldx. The valid values of multiRefldx are 0, 1, and 3, which signal the first, the second, or the fourth reference line. They are binarized as 0, 10, 11, respectively, where the two bins are context-encoded with two separate contexts by CABAC. When multiRefldx is non-zero, (meaning either the second or the fourth reference line is used), the prediction mode always belongs to the MPM list. Thus, the mpmFlag is not encoded. Furthermore, the PLANAR mode is excluded from the list as the two reference lines are offset from the target block. As the PLANAR mode is always the first candidate in the MPM list, this means that, when multiRefldx is non-zero, only five prediction modes are available as possible candidates. Thus, when multiRefldx is non-zero, the prediction mode is encoded as shown in Table 3. All 4 bins of the binarization are bypass encoded by CABAC.

TABLE 3
MPM encoding in a proposal when multiRefIdx > 0

| Candidate | |
|---|---|
| Index | code |
| MPM[1] | 0 |
| MPM[2] | 10 |
| MPM[3] | 110 |
| MPM[4] | 1110 |
| MPM[5] | 1111 |

### Proposed Intra Mode Coding

In regular intra prediction or intra prediction with sub-partitions (ISP), the intra mode coding in VTM 6.0 is kept unchanged. In both cases, multiRefldx is equal to zero as the first reference line is used for the prediction. The encoding of the mpmFlag in VTM 6.0 is kept unchanged. In intra prediction with MRL, when multiRefldx is non-zero, the mpmFlag is set as 1 and encode it with a separate context in CABAC. The index of the candidate MPM is then binary encoded as shown in Table 3, and all the bins are bypass encoded by CABAC.

At the decoder side, the mpmFlag is always decoded irrespective of the value of multiRefldx flag. However, the context used in parsing of the flag is decided based on the value of the multiRefldx flag. If multiRefldx flag is decoded to be zero, as is the case with regular intra prediction or intra prediction with sub-partitions, the mpmFlag is parsed with the CABAC context given in VTM 6.0. If multiRefldx is decoded to be nonzero, then a second CABAC context is used in parsing of the mpmFlag. The bins of the candidate MPM are then bypass decoded by CABAC. In both cases, the prediction mode of the CU is then decoded as the MPM candidate having the decoded index value.

Advantageously, the CABAC initial probability parameter when multiRefldx is not 0 (second context) is set to produce a high probability (close to 1) as the mpmFlag is forced as 1 in this case.

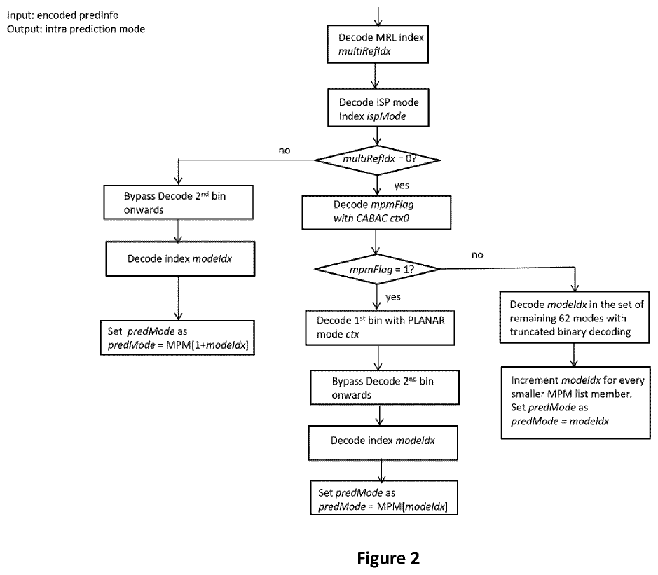

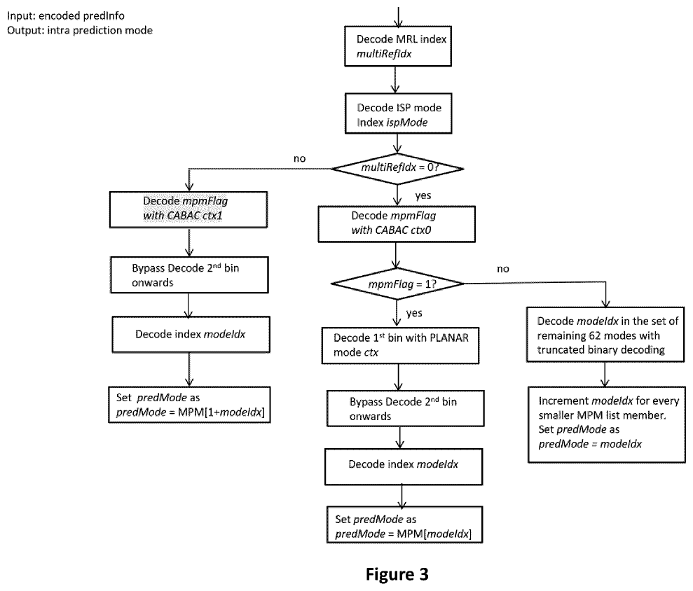

FIG. 2 and FIG. 3 display the flowgraphs of intra mode decoding in VTM 6.0 and in our proposal, respectively. The highlighted block in FIG. 3 shows the change in the current proposal with respect to VTM 6.0 implementation.

### CABAC Context Selection

The following description explains the rationale of the CABAC initialization process change. In another proposal, the initial probability value of the CABAC model is given by a linear model depending on the QP (quantization parameter):

proba(QP)=(a/2)*(QP−16)+b

where “a” and “b” denote the slope and the offset, respectively. Both the “a” and “b” are hardcoded in the specifications for a given bin corresponding to a syntax element. As the CABAC updates the probability at each read bin, two “window sizes” are also used to update the symbol probability. Depending on the window size, the probability update will be fast or slow. For example, for the initial CABAC parameters of original MPM flag, the probability is approximatively 0.57 (corresponding to a parameter of 36 in VTM-6.0) for a QP of 32 for inter frames (not depending on the QP, i.e. the slope is null), and a probability of 0.77 for intra frames (corresponding to an initial parameter of 45 in VTM-6.0).

In order not to penalize a low complexity encoder, that would perform the mpmFlag encoding when multiRefldx>0, it is proposed to initialize the CABAC probability with a high probability model, with b large. For example: a=0 (slope is null, i.e. no dependence on the QP) and b=0.99 (corresponding to an initial CABAC parameter of 39). Other values giving high initial probability can also be used. For example, keeping the initial probability function of the QP, a=0. b=0.99 (corresponding to an initial CABAC parameter of 47).

By using these initial probability models, a low complexity encoder, like the one described in another proposal that would also perform the encoding of mpmFlag when multiRefldx>0, does not have performance penalty (performance remains roughly the same), but a more complex encoder can leverage the new available feature if needed.

### Experimental Results

The proposed mpmFlag signaling with the VTM 6.0 codec was implemented in All Intra (Al) configuration with common test conditions. Table 4 shows the BD-rate performance of the proposed change versus the VTM 6.0 anchor. Observe that the BD-rate performance and the complexity are about the same as in VTM 6.0.

TABLE 4
BD-rate performance of the proposed method with
respect to VTM 6.0 anchor.

| | OverVTM-6.0 | | | | |
|---|---|---|---|---|---|
| | Y | U | V | EncT | DecT |
| Class A1 | −0.01% | 0.06% | −0.02% | 101% | 100% |
| Class A2 | 0.01% | 0.00% | 0.00% | 101% | 100% |
| Class B | 0.00% | −0.01% | −0.01% | 101% | 100% |
| Class C | 0.00% | 0.00% | 0.02% | 99% | 100% |
| Class E | 0.00% | 0.03% | 0.02% | 98% | 100% |
| Overall | 0.00% | 0.01% | 0.00% | 100% | 100% |
| Class D | 0.00% | 0.00% | 0.06% | 97% | 100% |
| Class F | 0.00% | −0.03% | 0.05% | 97% | 100% |
| (optional) | | | | | |

One advantage of the proposed method is rather homogeneity in syntax and parsing at the decoder. Furthermore, as it allows the mpmFlag to be signaled with the MRL intra prediction, all intra prediction modes can be considered with all reference lines available for a CU.

This document describes a variety of aspects, including tools, features, embodiments, models, approaches, etc. Many of these aspects are described with specificity and, at least to show the individual characteristics, are often described in a manner that can sound limiting. However, this is for purposes of clarity in description, and does not limit the application or scope of those aspects. Indeed, all the different aspects can be combined and interchanged to provide further aspects. Moreover, the aspects can be combined and interchanged with aspects described in earlier filings as well.

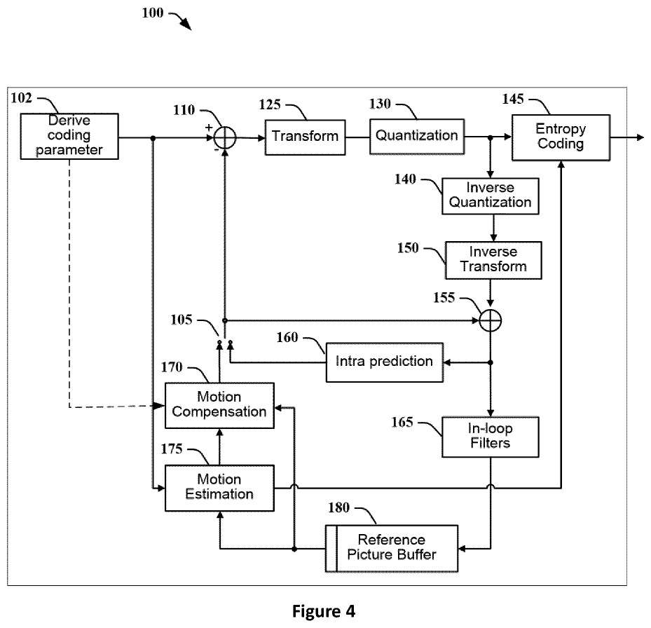

The aspects described and contemplated in this document can be implemented in many different forms. FIGS. 4, 5, and 6 below provide some embodiments, but other embodiments are contemplated and the discussion of FIGS. 4, 5, and 6 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

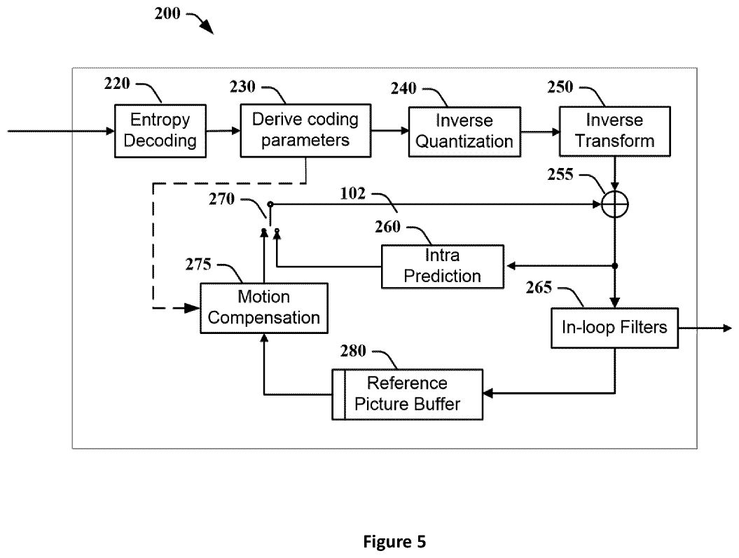

Various methods and other aspects described in this document can be used to modify modules, for example, the intra prediction, entropy coding, and/or decoding modules (160, 360, 145, 330), of a video encoder 100 and decoder 200 as shown in FIG. 4 and FIG. 5. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this document can be used individually or in combination.

Various numeric values are used in the present document, for example, {{1,0}, {3,1}, {1,1}}. The specific values are for example purposes and the aspects described are not limited to these specific values.

FIG. 4 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 5 illustrates a block diagram of a video decoder 200. In the decoder 200, a bitstream is decoded by the decoder elements as described below. Video decoder 200 generally performs a decoding pass reciprocal to the encoding pass as described FIG. 4. The encoder 100 also generally performs video decoding as part of encoding video data.

The input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

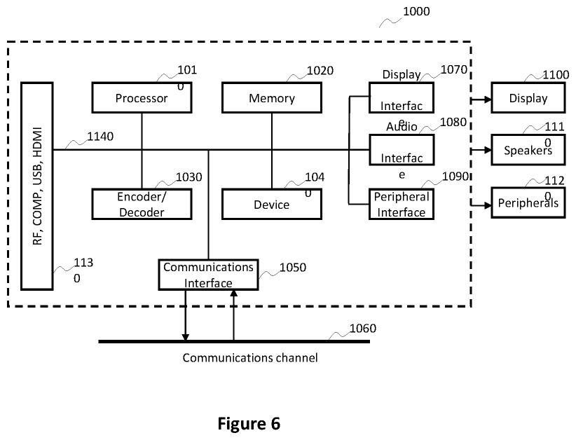

FIG. 6 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit, multiple ICs, and/or discrete components. For example, in at least one embodiment, the processing and encoder/decoder elements of system 1000 are distributed across multiple ICs and/or discrete components. In various embodiments, the system 1000 is communicatively coupled to other similar systems, or to other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device).

System 1000 includes a storage device 1040, which can include non-volatile memory and/or volatile memory, including, but not limited to, EEPROM, ROM, PROM, RAM, DRAM, SRAM, flash, magnetic disk drive, and/or optical disk drive. The storage device 1040 can include an internal storage device, an attached storage device, and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In several embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of a television. In at least one embodiment, a fast, external dynamic volatile memory such as a RAM is used as working memory for video coding and decoding operations, such as for MPEG-2, HEVC, or VVC (Versatile Video Coding).

The input to the elements of system 1000 can be provided through various input devices as indicated in block 1130. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 1130 have associated respective input processing elements as known in the art. For example, the RF portion can be associated with elements necessary for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the I2C bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed to the system 1000, in various embodiments, using a wireless network, such as IEEE 802.11. The wireless signal of these embodiments is received over the communications channel 1060 and the communications interface 1050 which are adapted for Wi-Fi communications, for example. The communications channel 1060 of these embodiments is typically connected to an access point or router that provides access to outside networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130.

The system 1000 can provide an output signal to various output devices, including a display 1100, speakers 1110, and other peripheral devices 1120. The other peripheral devices 1120 include, in various examples of embodiments, one or more of a stand-alone DVR, a disk player, a stereo system, a lighting system, and other devices that provide a function based on the output of the system 1000. In various embodiments, control signals are communicated between the system 1000 and the display 1100, speakers 1110, or other peripheral devices 1120 using signaling such as AV.Link, CEC, or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device, for example, a television. In various embodiments, the display interface 1070 includes a display driver, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, extracting an index of weights to be used for the various intra prediction reference arrays.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, weighting of intra prediction reference arrays.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion calculation or rate distortion optimization. During the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this document are not necessarily all referring to the same embodiment.

Additionally, this document may refer to “determining” various pieces of information. Determining the information can include one or more of, for example, estimating the information, calculating the information, predicting the information, or retrieving the information from memory.

Further, this document may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this document may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of weights to be used for intra prediction reference arrays. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

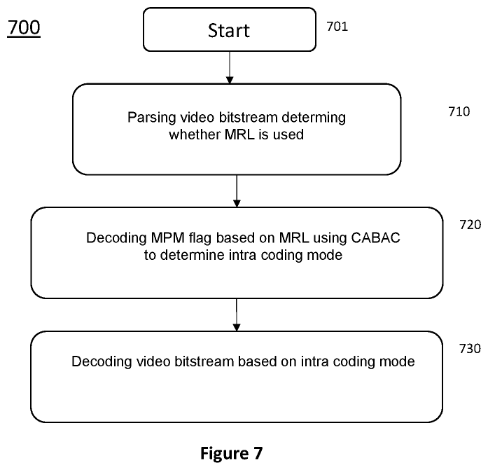

Embodiments may include one or more of the following features or entities, alone or in combination, across various different claim categories and types:
Setting a flag to indicate multiple reference lines and encoding it with a separate CABAC context.
Determining a context to be used in parsing a flag based on value of a multiple reference lines index flag.
Bypass decoding bins of a candidate most probable mode using CABAC.
A bitstream or signal that includes one or more of the described syntax elements, or variations thereof.
Creating and/or transmitting and/or receiving and/or decoding a bitstream or signal that includes one or more of the described syntax elements, or variations thereof.
A TV, set-top box, cell phone, tablet, or other electronic device that performs in-loop filtering according to any of the embodiments described.
A TV, set-top box, cell phone, tablet, or other electronic device that performs in-loop filtering according to any of the embodiments described, and that displays (e.g. using a monitor, screen, or other type of display) a resulting image.
A TV, set-top box, cell phone, tablet, or other electronic device that tunes (e.g. using a tuner) a channel to receive a signal including an encoded image, and performs in-loop filtering according to any of the embodiments described.
A TV, set-top box, cell phone, tablet, or other electronic device that receives (e.g. using an antenna) a signal over the air that includes an encoded image, and performs in-loop filtering according to any of the embodiments described.
   One embodiment of a method 700 under the general aspects described here is shown in FIG. 7. The method commences at start block 701 and control proceeds to block 710 for parsing a video bitstream to determine whether multiple reference line intra coding is used. Control proceeds from block 710 to block 720 for decoding a most probable mode flag based on the determination using a CABAC context to determine an intra coding mode. Control proceeds from block 720 to block 730 for decoding the video bitstream based on the intra coding mode.

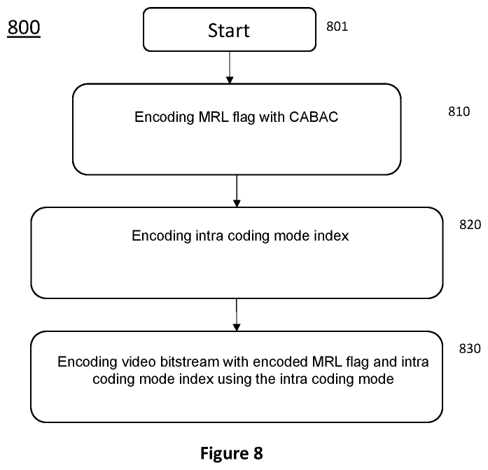

One embodiment of a method 800 under the general aspects described here is shown in FIG. 8. The method commences at start block 801 and control proceeds to block 810 for encoding a flag indicative of multiple reference line intra video coding with a CABAC context. Control proceeds from block 810 to block 820 for encoding an intra coding mode index representative of an intra coding mode used. Control proceeds from block 820 to block 830 for encoding a video bitstream with said encoded flag and intra coding mode index using said intra coding mode.

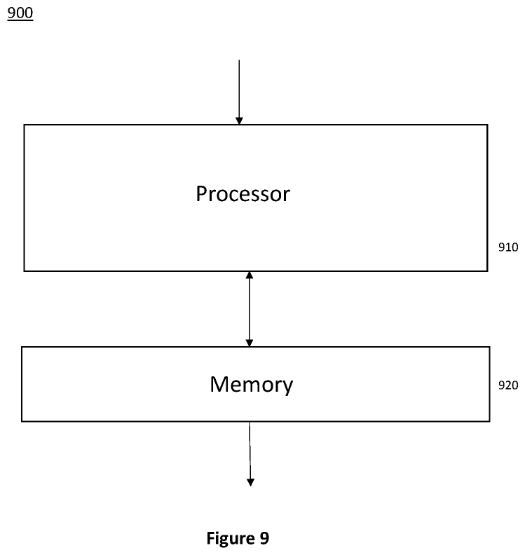

FIG. 9 shows one embodiment of an apparatus 900 for encoding, decoding, compressing or decompressing video data using simplifications of coding modes based on neighboring samples dependent parametric models. The apparatus comprises Processor 910 and can be interconnected to a memory 920 through at least one port. Both Processor 910 and memory 920 can also have one or more additional interconnections to external connections.

Processor 910 is also configured to either insert or receive information in a bitstream and, either compressing, encoding or decoding using any of the described aspects.

Various other generalized, as well as particularized, inventions and claims are also supported and contemplated throughout this description.

1. A method, comprising:
parsing a video bitstream to determine whether multiple reference line intra coding is used;
decoding a most probable mode flag based on said determination using a CABAC context to determine an intra coding mode; and,
decoding said video bitstream based on said intra coding mode wherein non-MPM modes are used with farther two reference layers.

2. An apparatus, comprising:
a processor, configured to:
parse a video bitstream to determine whether multiple reference line intra coding is used;
decode a most probable mode flag based on said determination using a CABAC context to determine an intra coding mode; and,
decode said video bitstream based on said intra coding mode wherein non-MPM modes are used with farther two reference layers.

3. A method, comprising:
encoding a flag indicative of multiple reference line intra video coding with a CABAC context;
encoding an intra coding mode index representative of an intra coding mode used; and,
encoding a video bitstream with said encoded flag and intra coding mode index using said intra coding mode wherein non-MPM modes are used with farther two reference layers.

4. An apparatus, comprising:
a processor, configured to:
encode a flag indicative of multiple reference line intra video coding with a CABAC context;
encode an intra coding mode index representative of an intra coding mode used; and,
encode a video bitstream with said encoded flag and intra coding mode index using said intra coding mode wherein non-MPM modes are used with farther two reference layers.

5. The method of claim 3, wherein said flag indicative of multiple reference line intra video coding has a value of one.

6. The method of claim 3, wherein said index representative of an intra coding mode used is binary encoded.

7. The method, of claim 6, wherein bins of said index are bypass encoded using CABAC.

8. The method of claim 1, wherein bins of said index are bypass decoded using CABAC.

9. The method of claim 1, wherein a CABAC probability parameter is initialized with a high probability model.

10. The method of claim 9, wherein said most probable mode flag is set to a value of one.

11. The method of claim 1, wherein said most probable mode flag is decoded regardless of a value of a multiple reference line intra coding index.

12. A device comprising:
an apparatus according to claim 2; and
at least one of (i) an antenna configured to receive a signal, the signal including the video block, (ii) a band limiter configured to limit the received signal to a band of frequencies that includes the video block, and (iii) a display configured to display an output representative of a video block.

13. A non-transitory computer readable medium containing data content generated according to the method of claim 3, for playback using a processor.

14. A computer program product comprising instructions which, when the program is executed by a computer, cause the computer to carry out the method of claim 1.

15. A computer program product comprising instructions which, when the program is executed by a computer, cause the computer to carry out the method of claim 3.

16. The apparatus of claim 4, wherein said flag indicative of multiple reference line intra video coding has a value of one.

17. The apparatus of claim 4, wherein said index representative of an intra coding mode used is binary encoded.

18. The apparatus of claim 17, wherein bins of said index are bypass encoded using CABAC.

19. The apparatus of claim 2, wherein bins of said index are bypass decoded using CABAC.

20. The apparatus of claim 2, wherein a CABAC probability parameter is initialized with a high probability model.
